(19) United States
(12) Patent Application Publication
(10) Pub. No.: US 2015/0335072 A1
(43) Pub. Date: Nov. 26, 2015

(54) ELECTRONIC CIGARETTE BATTERY UTILITY ATTACHMENT SYSTEM AND METHOD

(71) Applicant: Boris Giller, Toronto (CA)

(72) Inventor: Boris Giller, Toronto (CA)

(21) Appl. No.: 14/287,192

(22) Filed: May 26, 2014

(51) Int. Cl. A24F 47/00; F21V 33/00; H01S 3/02; B01F 13/00; B01F 15/00

(52) U.S. Cl. CPC A24F 47/008; B01F 13/002; B01F 15/00519; H01S 3/025; F21V 33/0004

(57) ABSTRACT

An electronic cigarette battery utility attachment system and method, comprising an electronic cigarette battery and an attachment kit further comprising a base having threads, a electrical/electronic component connected to the base, a casing that holds the electrical/electronic component and connects to the base on the bottom and a device connected to the top of the casing wherein the attachment kit screws onto the electronic cigarette battery whereby the attachment kit is powered by the electronic cigarette battery thereby converting the attachment kit into a new utility device.

### FIELD OF THE INVENTION

The present invention relates to attachments and electronic cigarette battery. More particularly, the present invention relates to a kit of attachments, each attachment to be powered by electronic cigarette battery which results in the formation of a new tool.

### BACKGROUND OF THE INVENTION

With the progress of technology, many products are equipped with or realized by electronic functions so as to improve the prior art defects and provide more functions. To improve the confinement and defects of conventional cigarettes, electronic cigarettes were developed. Electronic cigarette is an electrical device that simulates the act of tobacco smoking by producing an inhaled mist having the appearance, the physical sensation, and the flavor and nicotine content of inhaled tobacco smoke without the harmful health risks of conventional smoking products. Electronic cigarettes are becoming a popular alternative to tobacco smoking because of the many advantages that they offer. One of the main reasons that they are popular is due to their similarities to tobacco smoking. In fact, the closer that they are in providing the experience of a traditional cigarette, the more likely they are to be accepted in the market place.

An electronic cigarette typically comprises a battery, an atomizer, a container of smoke juice, a heating element and a power control circuit. One example of an electronic cigarette is a “two-piece” device having a first battery section and a second atomizer section, wherein the atomizer section is detachable from the battery section. The battery is used to power the circuit and the atomizer, where the atomizer heats the smoke juice to create smoke or vapor, which is inhaled by a user. There are many different kinds of electronic cigarette batteries in the market, such as battery with LCD display, volt adjustable battery, short circuit protection battery, general battery etc. Besides, the outlook of an electronic cigarette battery can be customized. Battery with LCD display: not only show the volt, but also show the remainder puffs. Volt adjustable battery: can adjust its volt, the higher volt it has, more the smoke the smoker gets. Short circuit protection battery: it keeps the electric current stable and protects the battery by limiting the electric current.

As the electronic cigarette offers numerous advantages, more and more consumers are beginning to use electronic cigarettes today. As a result, parts of electronic cigarette, such as the batteries, are also becoming readily available in the market.

On the other hand, there are also available in the market hand-held small devices such as a nail polisher, mini compressor, shaker, flashlight, micro-drill and many more. For these devices, the power source is either the mains or the batteries. If the power is to be sourced from the mains during the use, the utility of the device becomes restricted as the device can then be used only at the places where a nearby mains power source is available. Again, if the battery compartment of a battery powered hand held devices is an integral part of the device, then it becomes a problem as carrying a number of such hand held devices coupled with individual power source would take a lot of space. Again, as these devices would require their own power source they would cost much more and would not be modular.

Therefore, it would be desirable to get a solution through a system to utilize a single battery as a common power source for devices such as a fan, a laser pointer, a micro drill etc. instead of having each of these tools with battery separately.

Consequently, there exists in the art a long felt need for a system which enables use of a common power source for different devices. Additionally, there exists in the art a long felt need for a system which enables the use of electronic cigarette batteries to power devices other than vaporizers in a modular fashion and a system which provides a device that is significantly cheaper, more space economical and easier to replace than the conventional way.

### SUMMARY OF THE INVENTION

The above-mentioned problems and others not expressly discussed herein are addressed by the present subject matter and will be understood by reading and studying this specification.

Accordingly, there is provided an electronic cigarette battery utility attachment system which comprises of an attachment kit and an electronic cigarette battery with threaded portion in accordance to an embodiment of the present invention. The attachment kit further comprises a base, an electrical/electronic component, a device and a casing. The attachments include but not limited to devices such as a laser diode, an electric motor fan, a micro drill, a flashlight, a blender, a nail polisher and the like. The base is a standard ego clearomizer (metallic threaded) base. The casing holds the electrical/electronic component and the device together. The device is connected to the top part of the casing. The electrical/electronic component is connected to the metallic threaded base at the bottom of the casing. The casing also holds the electrical/electronic component and the metallic threaded base together. The electrical/electronic component connects to the positive and negative ends of the metallic threaded base by electrical wires. The attachment kit and the electronic cigarette battery are physically and electrically connected by a threaded engagement thereby converting the attachment kit into a new utility device. The attachment kit and the electronic cigarette battery are detachably attached to each other.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following figures and detailed description. It is intended that all such additional systems, methods, features and advantages that are included within this description, be within the scope of the accompanying claims.

### BRIEF DESCRIPTION OF DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of a conventional electronic cigarette battery and cartomizer in detached condition;

FIG. 2 is a diagram of a utility attachment kit with electronic cigarette battery in accordance with one embodiment of the present invention;

FIG. 3 is diagram of a utility attachment kit assembled and fitted to electronic cigarette battery in accordance with one embodiment of the present invention;

FIG. 4A illustrates a blender as an electronic cigarette battery utility attachment in accordance with one embodiment of the present invention;

FIG. 4B illustrates a laser pointer as an electronic cigarette battery utility attachment in accordance with one embodiment of the present invention;

FIG. 4C illustrates a flashlight as an electronic cigarette battery utility attachment in accordance with one embodiment of the present invention;

### DETAILED DESCRIPTION OF THE INVENTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

By way of introduction, an electronic cigarette battery utility attachment system of the present invention may include an attachment kit to be powered by electronic cigarette battery. The attachments include but not limited to devices such as a laser diode, an electric motor fan, a micro drill, a flashlight, a blender, a nail polisher and the like. For convenience, laser diode, electric motor fan, micro drill, flashlight, blender, nail polisher and the like will simply be referred to as a device hereinafter, it being best understood that a laser diode, an electric motor fan, a micro drill, flashlight, blender, nail polisher and the like are intended unless otherwise stated. Most commonly electronic cigarette batteries use a standard thread and a manual on-off button to operate an atomizer of liquid to produce a vapor that looks and feels like smoke. In one embodiment of the present invention, instead of an atomizer, the electronic cigarette battery is used to operate the attachment kit. The attachment kit further includes a base, an electrical component, a device and a casing.

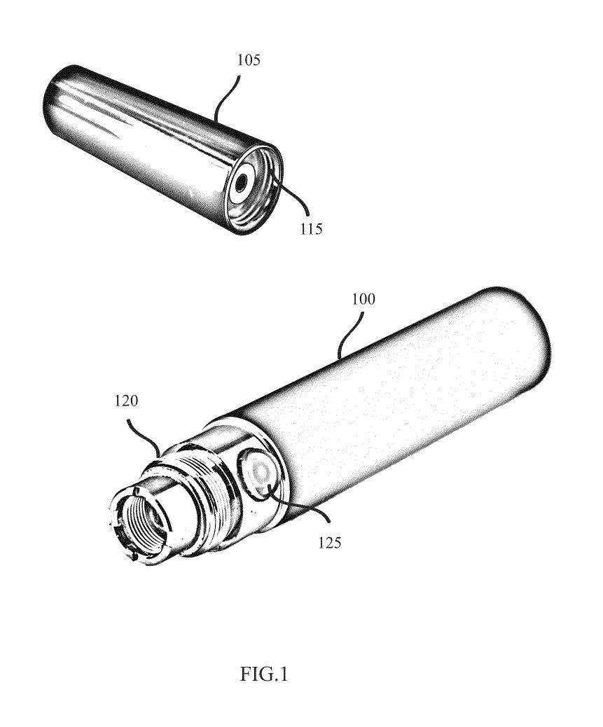

FIG. 1 illustrates an example of one conventional electronic cigarette with battery 100 and cartomizer 105 in detached condition. Cartomizer 105 is a device consisting of an atomizer and a cartridge all in one piece that connects to the battery 100. The battery 100 has male thread 120 which screws onto to female thread 115 of cartomizer 105. Also shown is power button 125 by means of which the battery power can be switched on and off.

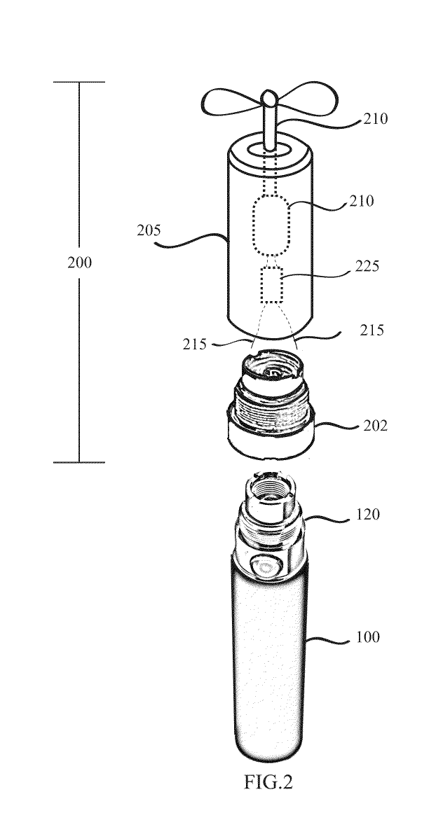

FIG. 2 illustrates an electronic cigarette battery utility attachment system which comprises of an attachment kit 200 and an electronic cigarette battery 100 with threaded portion 120 in accordance to an embodiment of the present invention. The attachment kit 200 further comprises a base 202, an electrical/electronic component 225, a device 210 and a casing 205. The base 202 is a standard ego clearomizer (metallic threaded) base. The casing 205 holds the electrical/electronic component 225 and the device 210 together. The device 210 is connected to the top part of the casing 205. The electrical/electronic component 225 is connected to the metallic threaded base 202 at the bottom of the casing 205. The electrical/electronic component 225 connects to the positive and negative ends of the metallic threaded base 202 by electrical wires 215. The casing 205 holds the electrical/electronic component 225 and the metallic threaded base 202 together by tight fit, glue, screws or by any suitable means known in the art. The casing 205 can be manufactured from any suitable material known in the art and can be manufactured in a variety of sizes, colors, shapes and designs without delineating from the scope of the invention. It is to be noted that the electronic cigarette battery 100 can be any electronic cigarette battery known in the art such as battery with LCD display, volt adjustable battery, short circuit protection battery and general battery and having a manual on and off button to send the current through the attachment kit 200. The electrical/electronic component 225 may have one or more diodes and the diodes work between 3-6 Volts in accordance with an embodiment of the present invention.

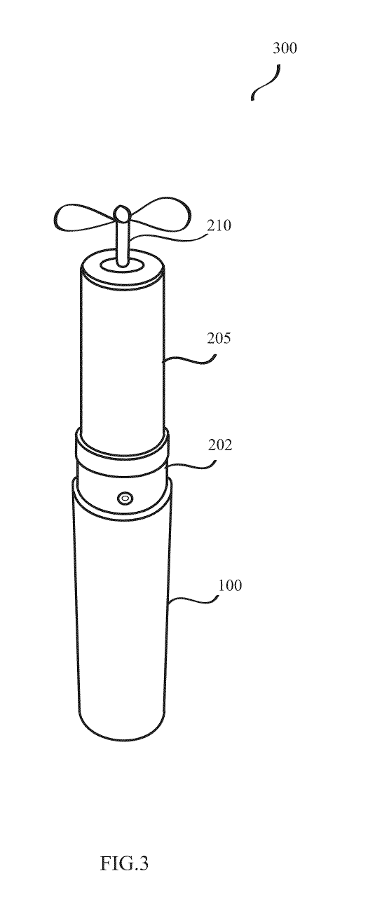

As best illustrated in FIG. 2 and FIG. 3, the attachment kit 200 and the electronic cigarette battery 100 are physically and electrically connected by a threaded engagement thereby converting the attachment kit 200 into a new utility device 300. The attachment kit 200 and the electronic cigarette battery 100 are detachably attached to each other.

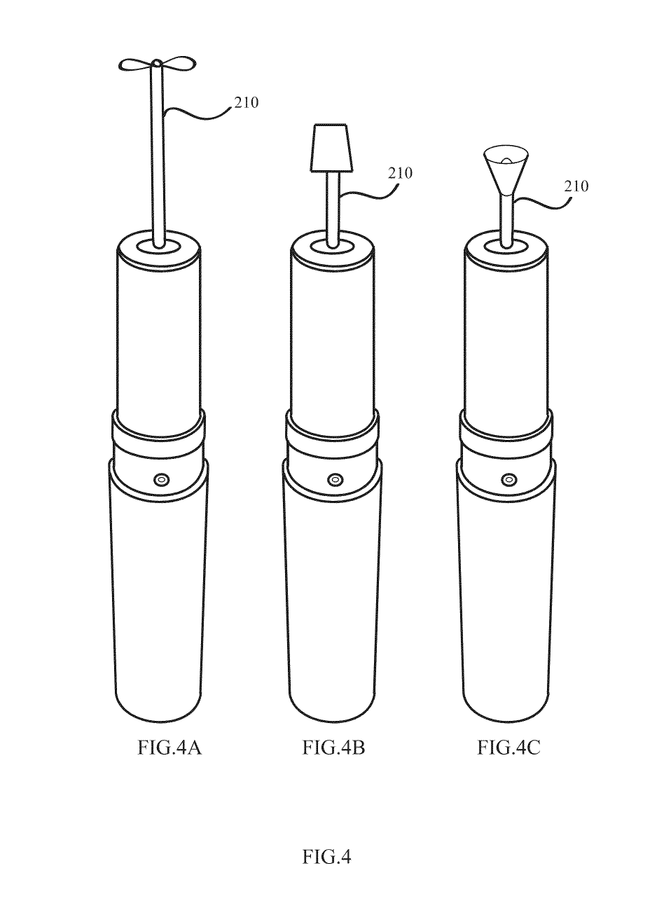

FIG. 4A illustrates a device 210, which is a blender, as an electronic cigarette battery utility attachment in accordance with one embodiment of the present invention.

FIG. 4B illustrates a device 210, which is a laser pointer, as an electronic cigarette battery utility attachment in accordance with one embodiment of the present invention.

FIG. 4C illustrates a device 210, which is a flashlight, as an electronic cigarette battery utility attachment in accordance with one embodiment of the present invention.

It is to be noted that, as would be obvious to any person skilled in the art, other devices and the like as discussed in the aforementioned description can be used as an attachment resulting in a new utility device 300.

In another embodiment of the present invention, a method of connecting an attachment kit 200 having an electrical/electronic component 225, a base 202 with metallic threads, a device 210 and a casing 205 to an electronic cigarette battery 100 comprises attaching the electrical/electronic component 225 to the base 202, holding together the electrical/electronic component 225 and the base 202 by the casing 205, attaching the device 210 with the casing 205 and screwing the attachment kit 200 onto the electronic cigarette battery 100. The attachment kit 200 is powered by the electronic cigarette battery 100 thereby converting the attachment kit 200 into a new utility device 300. The attachment kit 200 is detachably screwed to the electronic cigarette 100 battery. In order to connect the attachment kit 200 to an electronic cigarette battery 100, the base 202 of the attachment kit 200 is screwed to the threads of electronic cigarette battery 100.

It would be obvious to any person skilled in the art that, the concept of the present invention can be utilized, with little or no modification, to achieve similar result even when the battery of the electronic cigarette 100 has female threads and the cartomizer 105 has make threads.

Having described the system and method of the present invention, its use and advantages will be described now. The present invention enables different types of devices to be screwed on to an electronic cigarette battery and convert them into completely new utility devices. These new utility devices would not require their own power source separately for each device, would be cheaper and modular. Separately having these devices would take up a lot of space. The new utility devices formed by the present invention are space economical and easier to replace than the conventional way.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

What is claimed is:

1. An electronic cigarette battery utility attachment system, comprising:
an electronic cigarette battery; and
an attachment kit further comprising:
a base having threads;
at least one electrical/electronic component connected to said base;
a casing that holds said at least one electrical/electronic component and connects to said base on the bottom; and
a device connected to the top of said casing;
wherein said attachment kit screws onto said electronic cigarette battery whereby said attachment kit is powered by said electronic cigarette battery thereby converting said attachment kit into a new utility device.

2. The electronic cigarette battery utility attachment system, as in claim 1, wherein said attachment kit is detachably screwed to said electronic cigarette battery.

3. The electronic cigarette battery utility attachment system, as in claim 2, wherein said base with metallic threads is screwed to the threads of said electronic cigarette battery.

4. The electronic cigarette battery utility attachment system as in claim 1, wherein said base is a standard ego clearomizer base.

5. The electronic cigarette battery utility attachment system as in claim 1, wherein said at least one electrical/electronic component has at least one diode.

6. The electronic cigarette battery utility attachment system as in claim 1, wherein said electronic battery can be any electronic cigarette battery known in the art.

7. The electronic cigarette battery utility attachment system as in claim 5, wherein said electronic cigarette battery has a manual on and off button.

8. The electronic cigarette battery utility attachment system as in claim 1, wherein said new utility device is modular.

9. The electronic cigarette battery utility attachment system as in claim 1, wherein said electrical component is connected to the positive and negative ends of said base by electrical wires.

10. The electronic cigarette battery utility attachment system as in claim 1, wherein said casing holds together said electrical/electronic component and said base together by means of tight fit, glue, screws or by any suitable means known in the art.

11. The electronic cigarette battery utility attachment system as in claim 1, wherein said casing is manufactured from any suitable material known in the art.

12. The electronic cigarette battery utility attachment system as in claim 1, wherein said casing is manufactured in variety of sizes, shapes, designs and colours.

13. A method of connecting an attachment kit having at least one electrical/electronic component, a base with metallic threads, a device and a casing to an electronic cigarette battery, said method comprising:
attaching said at least one electrical/electronic component to said base with metallic threads;
holding together said at least one electrical/electronic component and said base by said casing;
attaching said device to the top of said casing; and
screwing said attachment kit onto said electronic cigarette battery;
wherein said attachment kit is powered by said electronic cigarette battery thereby converting said attachment kit into a new utility device.

14. The method of connecting an attachment kit having an electrical component, a base with metallic threads, a device and a casing to an electronic cigarette battery, as in claim 13, further comprises detachably screwing said attachment kit to said electronic cigarette battery.

15. The method of connecting an attachment kit having an electrical component, a base with metallic threads, a device and a casing to an electronic cigarette battery as in claim 14, further comprises screwing said base with metallic threads to the threads of said electronic cigarette battery.

16. The method of connecting an attachment kit having an electrical component, a base with metallic threads, a device and a casing to an electronic cigarette battery as in claim 13, wherein said base is a standard ego clearomizer base.

17. The method of connecting an attachment kit having an electrical component, a base with metallic threads, a device and a casing to an electronic cigarette battery of claim 13, wherein said electrical component have at least one diode.

18. The method of connecting an attachment kit having an electrical component, a base with metallic threads, a device and a casing to an electronic cigarette battery as in claim 13, wherein said electronic battery can be any electronic cigarette battery known in the art.

19. The method of connecting an attachment kit having an electrical component, a base with metallic threads, a device and a casing to an electronic cigarette battery as in claim 18, wherein said electronic cigarette battery has a manual on and off button.

20. The method of connecting an attachment kit having an electrical component, a base with metallic threads, a device and a casing to an electronic cigarette battery as in claim 13, wherein said new utility device is modular.
